(19) United States
(12) Patent Application Publication
(10) Pub. No.: US 2002/0148699 A1
(43) Pub. Date: Oct. 17, 2002

(54) Device for actuating a clutch

(76) Inventors: Rolf Mack, Sinzheim (DE); Thomas Lott, Buehl (DE); Rainer Becker, Beinheim (FR); Uwe Velte, Ottersweier (DE); Christian Meyer, Karlruhe (DE)

Correspondence Address: MALCOLM J ROMANO, 116 S CITRUS AVE, LOS ANGELES, CA, 90036, US

(21) Appl. No.: 10/088,580

(22) PCT Filed: Aug. 1, 2001
(86) PCT No.: PCT/DE01/02918

(30) Foreign Application Priority Data
Aug. 23, 2000 (DE) 100 41 447.8
Nov. 11, 2000 (DE) 100 56 004.0

(51) Int. Cl. F16D 27/00; F16D 29/00; F16H 61/32

(52) U.S. Cl. 192/83; 192/84.6; 192/91 R

(57) ABSTRACT

The invention is based on an apparatus for actuating a clutch, in particular for motor vehicle power units, comprising an electronically controllable clutch acutator (10, 42) that comprises an electric motor (12, 44) and a reduction control gear (14; 48, 52; 50, 54) and acts upon a clutch (36) via a transmission link (30). It is proposed that a plurality of electric motors (12, 44) acts upon a clutch (36) jointly in parallel and/or in series.

### RELATED ART

The invention is based on an apparatus for actuating a clutch according to the preamble of Claim 1.

Apparatuses for actuating a clutch are used for motor vehicle power units having an internal combustion engine and a mechanical transmission that can be shifted either fully or partially automatically, which apparatuses for actuating a clutch have an electronically controllable clutch actuator having an electric motor and a control gear. The clutch or clutches can be used to start the vehicle moving or to switch gears. Such a motor vehicle power unit is made known in U.S. Pat. No. 5,441,462, in which an electronic control unit controls a clutch actuator as a function of operating parameters and driving parameters.

Furthermore, a clutch actuator having an electric motor for engaging and disengaging a vehicle clutch is made known in DE 197 01 739 A1. Via a reduction gear in the form of a worm-gear pair having a worm and a worm gear, the electric motor actuates a plunger guided in a manner that allows it to be displaced in the axial direction that acts upon a master unit of a hydraulic transmission link to the clutch. Clutch actuators having different electric motors and reduction gears will be developed, produced, and stocked in accordance with the various applications that require different levels of actuating forces and actuator travel.

### ADVANTAGES OF THE INVENTION

According to the invention, a plurality of electric motors acts upon the clutch in parallel and/or in series. Based on the principle of modular systems, this allows the actuating force and actuator travel to be adjusted at the clutch for the particular application using few standard units. Installation space need be increased only slightly in order to increase the actuating work performed by the apparatus using a plurality of clutch actuators. On the one hand, this allows the system to be adapted to variable spaces in different vehicles by distributing the individual components among suitable available spaces. On the other hand, according to an embodiment of the invention, at least two clutch actuators can be accommodated in one housing in order to reduce the number of electrical connections, control leads, and supply lines, and to simplify production and installation. Moreover, new applications can be addressed using the modular system principle using available, proven individual components, which leads to cost savings in development, production, and storage.

If a plurality of clutch actuators is accommodated in the same housing, the actuating work performed by the individual electric motors can be summed up in the housing itself by means of a summing step, or in the course of a transmission link that follows the control gear. A simple means of attaining the object of the invention provides that, at the least, each of the control gears accommodated in the housing comprises an element capable of being displaced in the axial direction, and the elements are interconnected so they move together.

The clutch actuators accommodated in the housing can act upon a clutch jointly via an output across a path of the transmission link. Two outputs can also be provided, however, that can act upon the same clutch via largely separate paths of the transmission link, or upon different clutches via paths that are completely separate. The outputs and transmission links are designed for the intended assignment and the desired transmission behavior.

If a plurality of clutch actuators acts upon one clutch, the failure prevention of the apparatus can be enhanced by means of the redundant arrangement of the clutch actuator and the successive components. Additionally, the clutch actuators and the subsequent paths of the transmission link can be designed largely diverse in nature, which can enhance the failure prevention even further and modify the transmission behavior in many different ways.

The type of transmission link following the clutch actuator is optional. It can comprise a plurality of paths and comprise mechanical, hydraulic, or pneumatic components, or a combination of these. It can advantageously contain summing units that accumulate the actuating force and/or the actuator travel, that is, the actuating work, of the individual clutch actuators. Moreover, transformers can be provided in the transmission link to transform the accumulated actuating work into actuating forces and actuator travel as necessary for the respective application.

When the clutch is disengaged, the clutch actuators usually work against the force of one or more clutch springs. When the clutch is engaged, the clutch actuators are usually supported by the force of the clutch spring. It is therefore advantageous to provide energy accumulators that support the clutch actuator when the clutch is disengaged and that are loaded when the clutch is engaged. Such energy accumulators can be designed as spring-type actuators, the spring elements of which are preloaded during engagement of the clutch and which release tension during disengagement of the clutch. The spring elements can be designed as tension or compression springs in the form of helical springs, disc springs, gas-filled spring devices, rubber springs, etc. The spring-type actuators can also offset differences in the jointly-acting clutch actuators.

The individual clutch actuators can be advantageously controlled by means of an electronic control unit, e.g., a complete, externally-located electronic system or integrated electronic control units already in place, whereby a control unit is assigned to each electric motor. The separate control units function either in self-supporting fashion or they are coupled according to the master-slave principle. With all variants it is advantageous to control the electric motors of the clutch actuators out of phase in such a manner that their starting currents do not accumulate. Furthermore, the level of the starting current can be limited by means of the electronic control. This allows the current fluctuations in the vehicle electrical system to be maintained at a lower level than would be possible using a single electric motor with high current consumption. The apparatus according to the invention is therefore capable of being integrated, in principle, in a typical vehicle electrical system in any vehicle.

### BRIEF DESCRIPTION OF THE DRAWING

Further advantages become evident in the following drawing description. Exemplary embodiments of the invention are shown in the drawing. The drawing, the description and the claims contain numerous features in combination. One skilled in the art will advantageously consider them individually as well and combine them into reasonable further combinations.

FIG. 1 shows a partial longitudinal view through a clutch actuator,

FIG. 2 shows a block diagram of an apparatus according to the invention,

FIG. 3 shows a variant of FIG. 2,

FIG. 4 shows a schematic layout of an apparatus of two clutch actuators in the same housing,

FIG. 5 shows a layout of FIG. 4, and

FIGS. 6-8 show variants of FIG. 4.

### DETAILED DESCRIPTION OF THE EXEMPLARY EMBODIMENTS

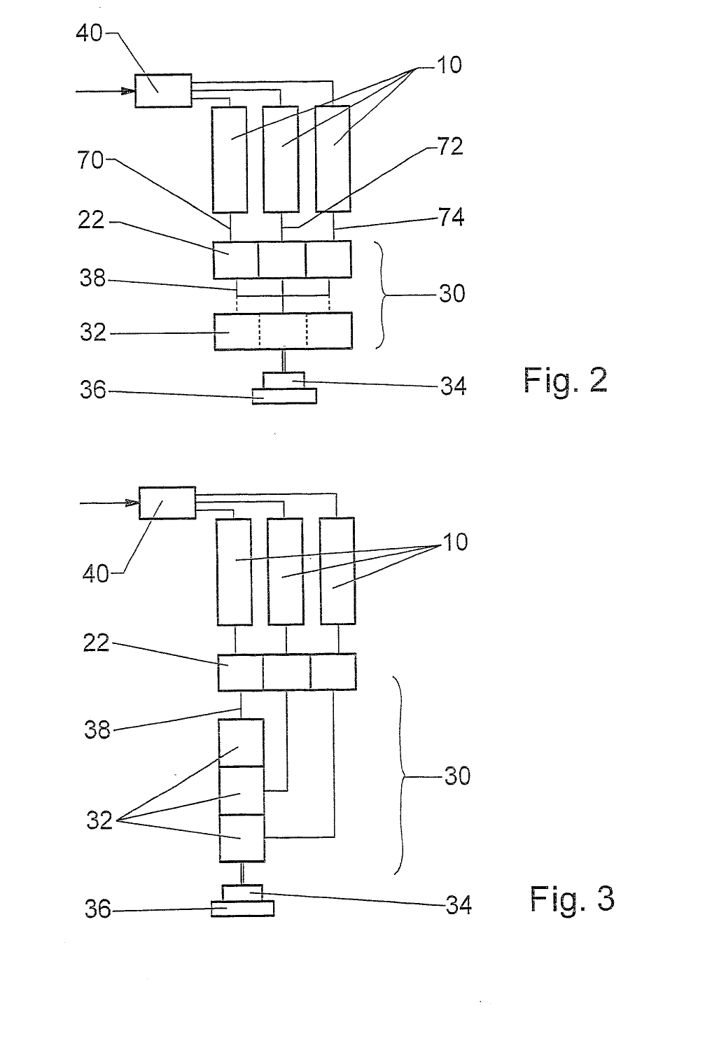

The apparatus according to the invention for actuating a clutch 36 comprises a plurality of clutch actuators 10 that act via a transmission link 30 upon an actuator 34 located directly at the clutch 36 (FIG. 2).

Each clutch actuator 10 includes an electric motor 12 capable of being controlled by an electronic control unit 40, and a control gear 14 designed as a reduction gear. The control gear 14 comprises a worm 16 driven by an electric motor 12 that meshes with a worm gear 18. This is pin-connected on the front side to a plunger 20 guided in a manner that allows it to be displaced in the axial direction that acts upon an input element of a master unit 22 of a transmission link 30.

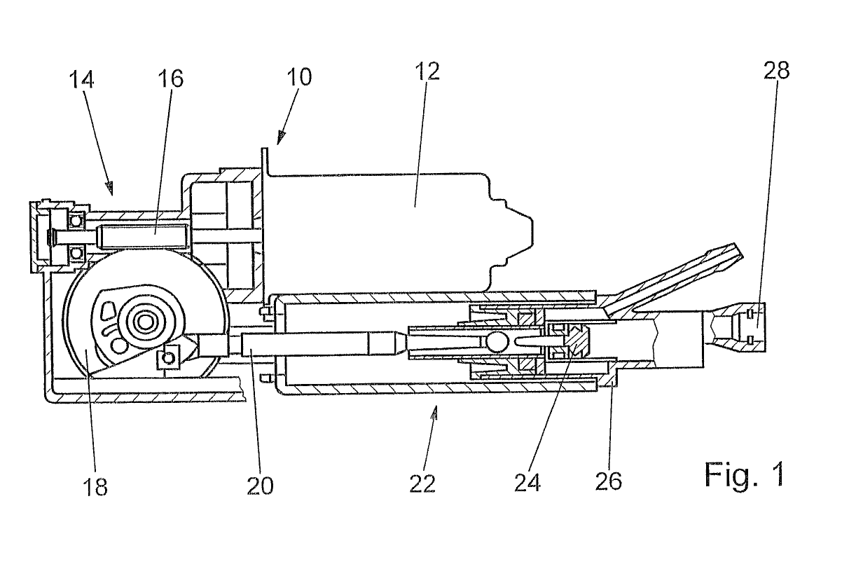

The transmission link 30 can comprise a plurality of paths 70, 72, 74 and contain mechanical, hydraulic, or pneumatic components. The transmission link 30 shown in the embodiment according to FIG. 1 is designed hydraulic in nature. The master unit 22 shown comprises, as the input element, a master-cylinder piston 24 that is connected to the plunger 20 and is guided in a master cylinder 26 is axially-displaceable fashion. A connection 28 is provided on the master cylinder 26 via which the master unit 22 is connected to an appropriately-designed slave unit 32 (not shown) at the actuator 34 by means of connecting lines 38.

The actuating force acting on the plunger 20 and the actuator travel achieved are determined by the torque of the electric motor 12 and the reduction ratio of the control gear 14. Accordingly, the piston 24 (FIG. 1) is displaced to the right when the clutch 36 is disengaged. At the same time, it displaces a volume of fluid in the master cylinder 26 that corresponds to its piston displacement and creates a pressure that is equal to the ratio of the actuating force acting on the plunger to the cross-sectional area of the master-cylinder piston 24. If the slave cylinder and the slave-cylinder piston of the slave unit 32 are the same as the master-cylinder piston 24 and master cylinder 26 of the master unit 22, the same actuating forces and actuator travels result at the slave unit 32 as at the master unit 22.

If a plurality of clutch actuators 10 is arranged parallel to each other, and if they act upon the actuator 34 across parallel, largely separate paths 70, 72, 74 of the transmission link 30, as indicated in FIG. 2 using dashed lines, then the actuating force is multiplied in accordance with the number of clutch actuators, with the same actuator travel. The slave units 32—distributed around the circumference—can thereby act upon the actuator 34 individually, or they can be integrated into one common slave unit 32, whereby the cross-sectional area of the common slave-cylinder piston corresponds to the sum of the cross-sectional areas of the master-cylinder piston 24. The summing of the actuating work of the clutch actuators 10 can thereby take place in the common slave unit or even at the output of the master units 22 by means of a common collecting line or a common collecting space.

FIG. 3 shows a variant that corresponds to a series connection of the clutch actuator 10. The master units 22 cooperate with slave units 32, which can also be integrated into one common slave unit 32. The cross-sectional areas of the slave-cylinder pistons and slave cylinders of the slave units 32, together, are equal to the cross-sectional areas of the master-cylinder pistons and master cylinders. If the slave units 32 are separated, a slave-cylinder piston in connected in series to a downstream slave cylinder, so that the actuator travels of the individual slave units accumulate. In the case of a common slave cylinder and slave-cylinder piston, the connecting lines 38—which can also be interconnected between the master units 22 and the common slave unit 32 by means of a collecting line—lead into the common slave cylinder of the slave unit 32, whereby the actuator travel is multiplied in accordance with the number of master units 22 if the cross-sectional area of the common slave-cylinder piston corresponds to the cross-sectional area of a master-cylinder piston. The ratio of actuating force to actuator travel can be modified by the ratio of the total cross-sectional area of the master units 22 to the common cross-sectional area of the slave unit 32. The actuating work remains constant if the number of clutch actuators 10 is not changed, however.

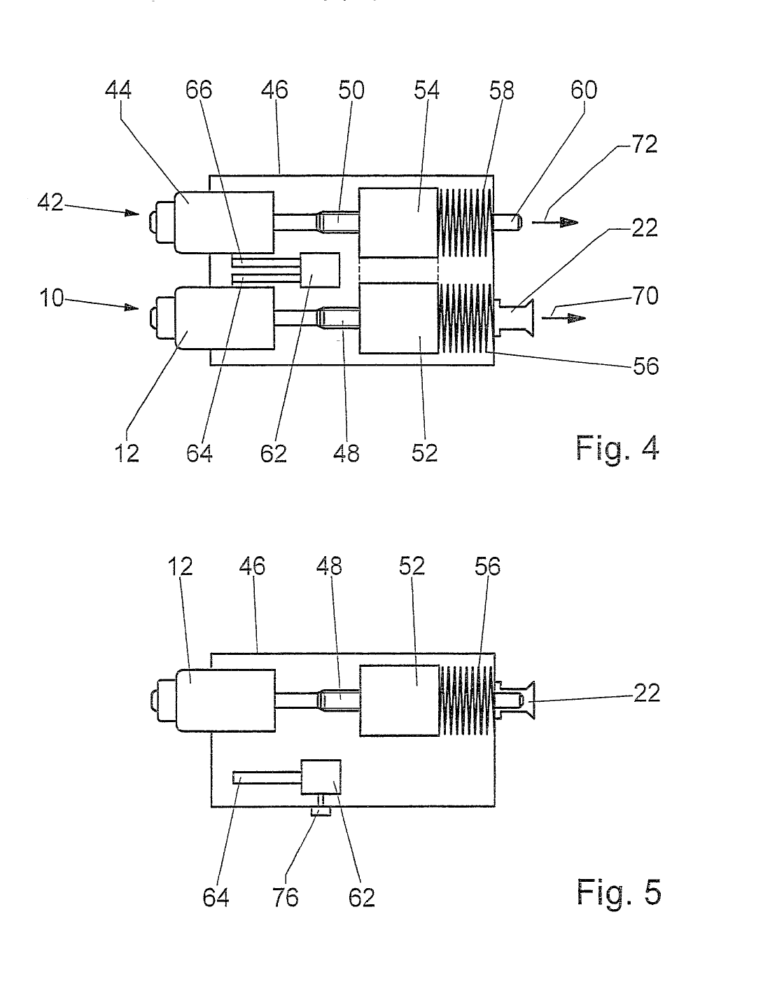

In the embodiment according to FIG. 4, two clutch actuators 10 and 42 are accommodated in one housing 46. The electric motors 12 and 44 drive threaded spindles 48 and 50 that cooperate with threaded nuts 52 and 54 and adjust them in the axial direction in accordance with the direction of rotation of the electric motors 12, 44. The threaded nuts 52, 54 act upon outputs 22, 60. Output 22 is a hydraulic master unit, while output 60 comprises a diverse mechanical configuration. The paths 70 and 72 of the transmission link 30 immediately follow the outputs 22 and 60. The two clutch actuators 10 and 42 can thereby act jointly upon one clutch 36, as described above, or they can operate two different clutches 36 which, under certain circumstances, require a different actuating behavior.

Energy accumulators 56, 58 in the form of spring elements act upon the threaded nuts 52, 54, the preload of which spring elements is increased when the clutches 36 are engaged, and that support the clutch actuators 10 and 42 when the clutches 36 are disengaged. As a result, the torque of the electric motor 12, 44 required to disengage the clutch 36 is reduced, and the torque required to engage the clutch 36 is adjusted to the disengagement torque. Moreover, differences in the course of torque of the clutch actuators 10 and 42 can be adjusted to each other by means of the energy accumulators 56, 58.

The redundant arrangement of the clutch actuators 10 and 42 as well as the redundant design of the paths 70 and 72 enhance the failure prevention of the apparatus according to the invention, and, to a particular extent, when the paths 70 and 72 are designed diverse in nature, e.g., hydraulic and mechanical.

The electric motors 12 and 44 of the clutch actuators 10 and 42 can act jointly on one output 22 or 60 by coupling the axially displaceable threaded nuts 52, 54 to each other. In this case, one of the outputs 22 or 60 is eliminated, depending on which transmission behavior is desired for the respective application.

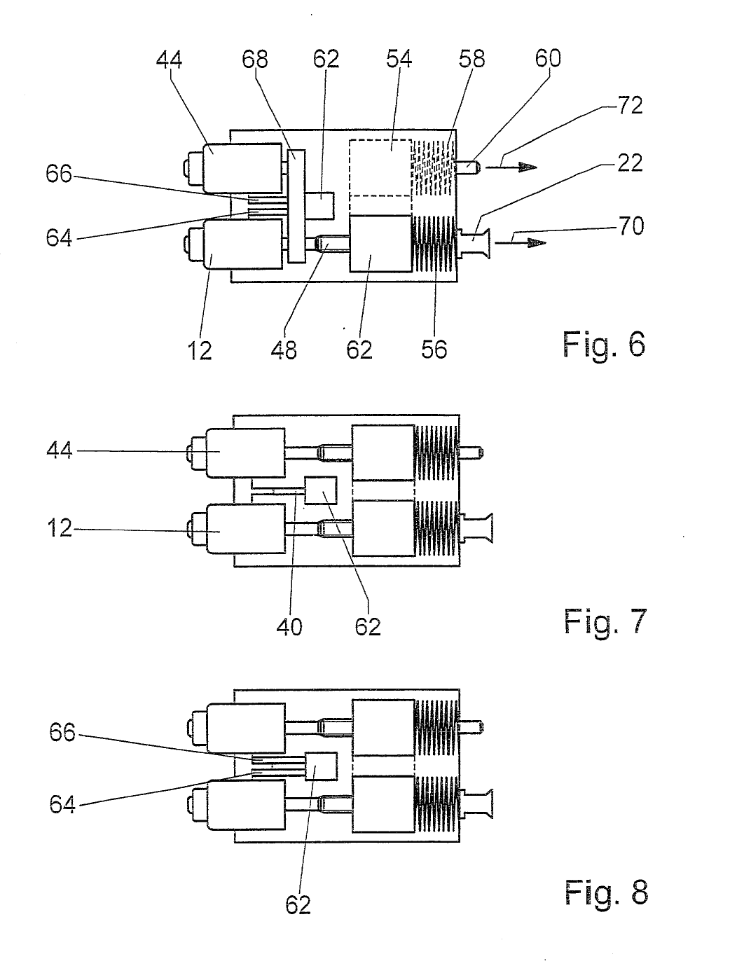

In the embodiment according to FIG. 6, the electric motors 12, 44 drive the threaded spindles jointly via a summing step 68, so that the accumulated actuating work of the electric motors 12 and 44 is available at the output 22. The threaded spindle 50 can also be driven via the summing step, of course, and, in fact, depending on which transmission behavior at the outputs 22 or 60 is desired.

The electric motors 12 of the clutch actuators 10 according to FIG. 2 or FIG. 3, and the electric motors 12 and 44 according to FIG. 7 are controlled by the common electronic control unit 40, while separate control units 64, 66 are assigned to the electric motors 12, 44 according to FIG. 4, FIG. 6, or FIG. 8. In the embodiment according to FIG. 8, the separate control units 64, 66 are coupled to each other according to the master-slave principle, so that one of the control units 64, 66 performs a “leadership” role. A common electrical connection 62 is provided for the control units 64, 66 that is connected to a vehicle electrical system (not shown) and external control elements via a plug connector 76.

In every variant, the electric motors 12, 44 are advantageously out of phase, so that their starting currents do not accumulate. Furthermore, the starting current of the individual electric motors 12, 44 is limited in advantageous fashion, so that the current fluctuations in the vehicle electrical system are maintained at a lower level than would be possible using a single electric motor with high current consumption.

What is claimed is:

1. An apparatus for actuating a clutch, in particular for motor vehicle power units, comprising an electronically controllable clutch acutator (10, 42) that comprises an electric motor (12, 44) and a reduction control gear (14; 48, 52; 50, 54) and acts upon a clutch (36) via a transmission link (30), wherein a plurality of electric motors (12, 44) acts upon a clutch (36) jointly in parallel and/or in series.

2. The apparatus according to claim 1 or the preamble of claim 1, wherein at least two clutch actuators (10, 42) are accommodated in the same housing (46) that comprises at least two outputs for various clutches (36).

3. The apparatus according to claim 1 or 2, wherein the transmission link (30) comprises mechanical, hydraulic and/or pneumatic summing units.

4. The apparatus according to one of the preceding claims, wherein the transmission link (30) comprises mechanical, hydraulic and/or pneumatic transformers.

5. The apparatus according to one of the preceding claims, wherein the transmission link (30) comprises a plurality of paths (72, 74) that are designed diverse in nature.

6. The apparatus according to one of the preceding claims, wherein each of the control gears (48, 52; 50, 52) comprises an axially adjustable element (52, 54), whereby at least two axially adjustable elements (52, 54) are coupled together so they move together.

7. The apparatus according to one of the preceding claims, wherein a summing step (68) is provided between the electric motors (12, 44) and the control gears (14; 48, 52; 50, 54).

8. The apparatus according to one of the preceding claims, wherein a common electronic control unit (40) is provided for at least two electric motors (12, 44).

9. The apparatus according to one of the preceding claims, wherein one separate control unit (64, 66) each is provided for at least two electric motors (12, 44).

10. The apparatus according to one of the preceding claims, wherein separate control units (64, 66) are assigned to at least two electric motors (12, 44) that are coupled to each other according to the master-slave principle.

11. The apparatus according to one of the preceding claims, wherein the electric motors (12) are controlled by the electronic control units (40, 64, 66) in phase-displaced fashion.

12. The apparatus according to one of the preceding claims, wherein at least one energy accumulator (56, 58) is provided that supports the electric motors (12, 44) during the disengaging motion of the clutch (36) and loads during the engaging motion of the clutch (36).

13. The apparatus according to claim 12, wherein the energy accumulator (56, 58) is a spring-type actuator.
